(19) United States
(12) Patent Application Publication
(10) Pub. No.: US 2012/0159970 A1
(43) Pub. Date: Jun. 28, 2012

(54) FILLING CONTAINERS WITH COMPRESSED MEDIA

(76) Inventors: Wilfried-Henning Reese, Unterschleissheim (DE); Heinz Posselt, Bad Aibling (DE); Harald Kraus, Munich (DE); Tobias Kederer, Pullach (DE)

(21) Appl. No.: 13/389,678

(22) PCT Filed: Aug. 6, 2010
(86) PCT No.: PCT/EP2010/004836

§ 371 Date: Feb. 29, 2012

(30) Foreign Application Priority Data
Sep. 1, 2009 (DE) 10 2009 039 645.4

(51) Int. Cl. F17C 13/00; F17C 13/08

(52) U.S. Cl. 62/53.2; 62/45.1

(57) ABSTRACT

A method and an arrangement for filling a storage container, in particular a storage tank of a vehicle, having a compressed medium, in particular compressed hydrogen, wherein the medium is temporarily stored in at least one high pressure storage container and immediately before being delivered to the storage container to be filled has a temperature that is within a predetermined temperature interval. The high-pressure storage containers, in which the medium is temporarily stored, are cooled and/or heated. Thus, the medium temporarily stored in the high-pressure storage container is temporarily stored substantially at the temperature at which it is delivered to the storage container to be filled.

The invention relates to an arrangement for filling a storage container, in particular a storage tank of a vehicle, with a compressed medium, in particular with compressed hydrogen, exhibiting
a) at least one supply tank, which is used to store the medium in a liquid and/or gaseous state,
b) at least one cryogenic pump and/or at least one compressor, which is used to compress the medium stored in the supply tank,
c) at least one high-pressure storage container, which is used to temporarily store the compressed medium, and
d) a system of lines through which the medium is delivered from the supply tank and/or high-pressure storage container to the storage container to be filled.

The invention further relates to a method for filling a storage container, in particular a storage tank of a vehicle, with a compressed medium, in particular with compressed hydrogen, wherein the medium is temporarily stored in at least one high-pressure storage container, and immediately before being delivered to the storage container to be filled exhibits a temperature lying within a prescribed temperature interval.

A generic arrangement along with a generic method for filling a storage container, in particular a storage tank of a vehicle, with a compressed medium, in particular with compressed hydrogen, are known from German patent application 102009019275, which was not previously published.

The term “vehicle” will in the following be understood to mean all types of surface vehicles, airplanes and vessels, which can be refueled with a pressurized, gaseous medium, in particular hydrogen. The term “medium” will in the following be understood to mean gases and gas mixtures, among other things.

Nearly all vehicle manufacturers are currently testing vehicles with fuel cell drives or modified combustion engines, in which hydrogen is used as the energy carrier. In addition to the depressurized storage of cryogenic, liquefied hydrogen on board such vehicles, tests are also being performed on the storage of gaseous hydrogen under a pressure of up to 700 bar.

There already exist hydrogen refilling stations where vehicles are refueled with gaseous hydrogen with pressures of up to 700 bar. In order to be able to refuel several vehicles one after the other or at the same time, use is generally made of refueling methods which involve temporarily storing large quantities of pressurized, gaseous hydrogen in corresponding pressure buffers. In addition, the compressor system to be provided must be dimensioned or configured in such a way as to guarantee the required volume flows.

At the present time, the following requirements are placed on hydrogen refilling stations: Refueling a vehicle tank with 5 kg of hydrogen under a pressure of 700 bar at room temperature; refilling or refueling time at most 180 seconds; the vehicle tank can be heated to at most 85° C. in the refilling process; it must be possible to realize at least three refuelings within 45 minutes and 10 refuelings per day.

In more recent hydrogen refilling stations, the switch is being made to providing a storage container for liquefied hydrogen, preferably equipped with vacuum superinsulation. As a result, the amount of compressed, gaseous hydrogen to be stored at the refilling station can be reduced. This positively affects the space required by the refilling station, as well as the safety of the refueling process. For these reasons, leading corporations and research facilities currently regard the use of liquid hydrogen for supplying a public refueling infrastructure as the most economic and flexible supply method.

So-called liquid or cryogenic pumps are provided so that the liquid hydrogen stored under virtually no pressure can be compressed to the desired storage pressure of up to 700 bar. Compressing the hydrogen by means of such cryogenic pumps is comparatively economical and inexpensive, since only a slight level of compression is required in order to convey or compress the liquid. As a result, only approx. 10% of the specific capacity of a compressor system is required to convey identical mass flows via a cryogenic pump at a pressure of 900 bar. At the same time, the physical dimensions of such cryogenic pumps are smaller by comparison to a conventional compressor system.

In addition, the hydrogen flow compressed by means of a cryogenic pump must no longer be subjected to an expensive cooling process, since the temperature at the outlet of the cryogenic pump is comparably low; it measures approx. 50 K. In order to prevent the vehicle tank from overheating, the hydrogen compressed to a pressure of 700 bar must be preliminarily cooled or heated to a temperature of −40° immediately before delivered into the vehicle tank. Due to vehicle tank specifications, temperatures of less than −40° C. are also not permissible. The hydrogen flow to be delivered to the vehicle tank must hence be conditioned to a comparatively narrow temperature range of approx. −38 to −40° C.

Known from the aforementioned patent application 102009019275 is a method for refueling a vehicle with a pressurized, gaseous medium, in particular pressurized, gaseous hydrogen, in which the medium to be delivered to the vehicle tank is cooled and/or heated to a temperature lying within the prescribed temperature interval by means of a unit heater.

The object of the present invention is to indicate a generic arrangement and generic method for filling a storage container, in particular a storage tank of a vehicle, with a compressed medium, in particular with compressed hydrogen, which avoids the disadvantages associated with the procedures described above.

This object is achieved by a proposed arrangement for filling a storage container, in particular a storage tank of a vehicle, with a compressed medium, in particular with compressed hydrogen, which is characterized by the fact that means for cooling and/or heating are allocated to the high-pressure storage container.

In terms of method, the set object is achieved by virtue of the fact that the high-pressure storage container(s) used for temporarily storing the medium is/are cooled and/or heated.

According to the invention, the medium temporarily stored in the high-pressure storage container(s) is now temporarily stored according to the invention substantially at the temperature at which it is delivered to the storage container to be filled.

The sequence of terms “temporarily stored . . . substantially at the temperature at which it is delivered to the storage container to be filled” means that the storage temperatures and filling temperatures, i.e., the temperature prevailing at the filling plug or nozzle, do not differ from each other by more than 10 K, preferably by no more than 5 K.

Additional advantageous embodiments of the arrangement according to the invention as well as the method according to the invention for filling a storage container are characterized in that
the medium temporarily stored in the high-pressure storage container(s) is temporarily stored substantially at the temperature at which it is delivered to the storage container to be filled,
the means for cooling and/or heating the high-pressure storage container are designed as a container that envelops the high-pressure storage container, and accommodates a coolant,
the container incorporates a recirculation pump, which is used to recirculate the coolant,
a glycol-water mixture, a cooling oil and/or a potassium formiate solution are used as the coolant, wherein an anti-corrosion additive can be added to the coolant,
the coolant is used as the cooling medium in cases where the system of lines is cooled at least partially by means of a cooling medium,
the means for cooling and/or heating the high-pressure storage container are configured as a cooling and/or heating device allocated to the individual high-pressure storage container(s),
the cryogenic pump and/or compressor have placed downstream from them at least one heat exchanger, which is preferably configured as an air heat exchanger and/or electric heater,
the compressor has placed upstream from it at least one heat exchanger, wherein the latter is preferably configured as an air heat exchanger and/or electric heater, and
at least a partial area of the system of lines arranged inside the coolant is configured as a heat exchanger.

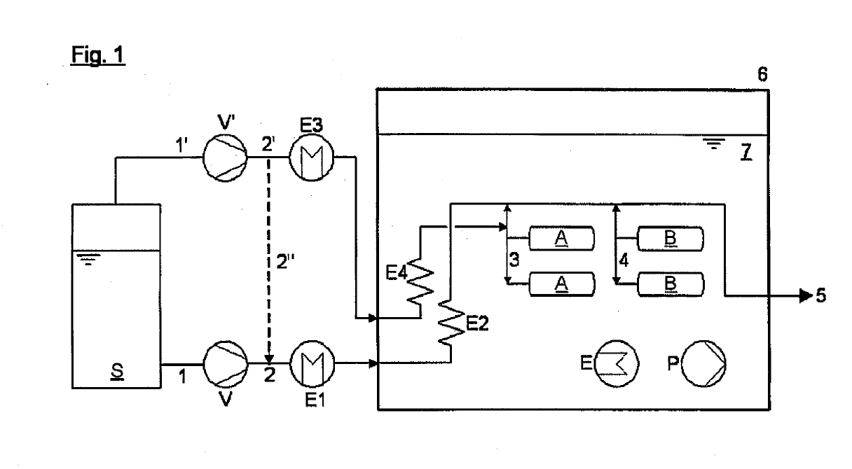

The arrangement according to the invention as well as the method according to the invention for filling a storage container and other configurations of the latter will be explained in greater detail below based on the exemplary embodiments shown on FIGS. 1 to 3.

FIG. 1 shows a supply tank S for liquefied hydrogen, which exhibits a storage volume of between 10 and 200 m³ hydrogen. Such storage containers for liquefied hydrogen are sufficiently known from prior art. Within the framework of hydrogen refilling stations, they are preferably underground, and vehicles to be refueled can drive over them.

Also provided are a cryogenic pump V and a compressor V′. The cryogenic pump V is supplied with liquid hydrogen from the supply tank S via the line 1, which is preferably vacuum (super)insulated in design. The cryogenic pumps V used in practice are geared especially to the existing requirements for filling up vehicles. They make it possible to compress liquid hydrogen of approx. 1 bar to about 900 bar in a two-stage compression process.

Gaseous hydrogen can be withdrawn from the supply tank S via the line 1′ and compressed to a pressure of between 100 and 700 bar by means of the compressor or compression unit V′.

Provided in addition to the supply tank S are several high-pressure storage containers A and B. In practice, the latter are combined into storage banks that usually cover at least three different pressure ranges. For example, the high-pressure storage containers A are designed for a storage pressure of between 400 and 700 bar, while the high-pressure storage containers B are designed for a storage pressure of between 300 and 500 bar. As a general rule, additional storage containers are provided, for example ones designed for a storage pressure of between 50 and 400 bar. However, it is also possible to realize methods in which only one or two storage banks or even only one or two high-pressure containers are provided.

According to the invention, the high-pressure storage containers A/B now have means for cooling and/or heating the high-pressure storage containers allocated to them. In the case of the exemplary embodiment depicted on the figure, these cooling and/or heating means are designed as a container 6 that envelops the high-pressure storage containers A/B, and incorporates a coolant 7. For example, this coolant is a glycol-water mixture or a cooling oil suitable for the intended application. The optionally provided pump P is used to recirculate the coolant 7. A heat exchanger E that operatively interacts with the cooling device not shown in the figure can be used to supply or remove heat to or from the coolant 7. However, the means for cooling and/or heating the high-pressure storage tanks A/B can also be designed as a cooling and/or heating device allocated to the individual high-pressure storage tank(s) A/B.

The system described above must be configured in such a way as to temporarily store the medium temporarily stored in the high-pressure containers A/B substantially at the temperature at which it is delivered by way of the lines 3 or 4 and 5 to the storage container to be filled, which is not shown on the figure for reasons of clarity. Hence, if a temperature of −20° C. or −40° C. is required at the transfer point (filling plug, nozzle, etc.), the medium should also be stored in the high-pressure storage containers A/B at these temperatures, wherein temperature differences between the storage and delivery temperature measuring in the single-digit range appear tolerable.

At the start of the refueling process, compressed hydrogen now first flows out of the high-pressure storage containers A/B to the storage container to be refilled via line segments 3 or 4 and 5. As soon as the storage containers A/B have been emptied, the hydrogen compressed by the cryogenic pump V to a pressure of up to 900 bar is delivered to the vehicle tank via the line segments 1, 2 and 5. It is especially advantageous that hydrogen expands as the medium or hydrogen streams from the storage containers A/B into the storage containers to be filled, wherein the expansion cooling that arises in the process can be used for cooling the coolant 7.

Once the high-pressure storage containers A/B have been emptied, they are refilled again by means of the cryogenic pump V and/or the compressor V′. When filling the high-pressure storage container A/B with the cryogenic pump V, the compressed medium is delivered to the high-pressure storage containers A/B via the line segments 2 as well as 3 and/or 4. Two heat exchangers E1 and E2 can here be provided in line segment 2, wherein the first heat exchanger E1 in the direction of flow is preferably designed as an air heat exchanger with or without a fan and/or electric heater, while the heat exchanger E2 is arranged inside the coolant 7. This second heat exchanger E2 is preferably designed as a tubular heat exchanger. The temperature is balanced to the desired storage temperature therein. Similarly to the described heat exchangers E1 and E2, the line segment 2′ can also be provided with two heat exchangers E3 and E4.

The heat exchangers E1 and/or E3 are to be provided in particular if the full amount of energy or heat cannot be imparted to the stored medium when filling the high-pressure storage container A/B due to an inadequate transfer of heat between the coolant 7 and compressed medium. In such cases, the heat exchangers E1 and/or E3 must ensure that the required heat is provided.

The compressor V′ is normally designed for a pressure range of at most 450 bar, while cryogenic pumps V at present compress up to a maximum of 900 bar. In light of these disparate pressure ranges, the cryogenic pump and compressor V′ in practice fill varying high-pressure storage containers A/B, which is why the medium compressed via compressor V′ in the exemplary embodiment shown on the figure is delivered only to the high-pressure container A by way of the line segments 2′ and 3. The medium compressed via compressor V′ can also be supplied to the high-pressure storage containers A/B by way of the dashed line 2″.

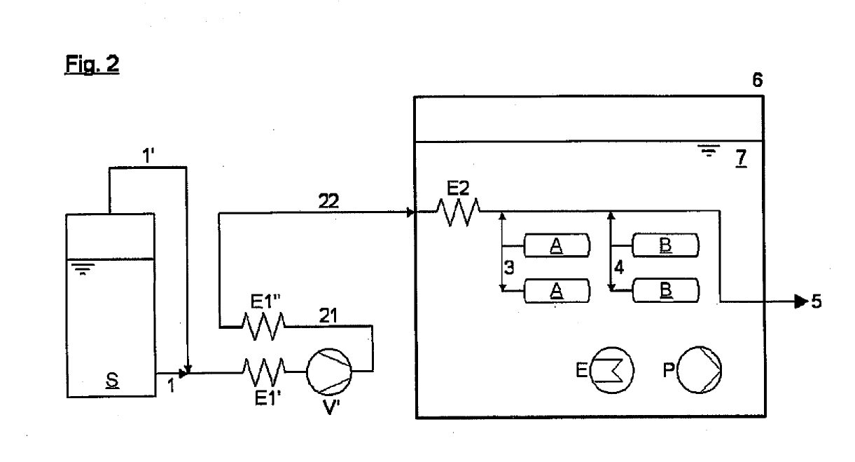

The exemplary embodiment shown on FIG. 2 differs from the one on FIG. 1 in that only a so-called “warm compression” is now realized. The hydrogen removed from the supply tank S via lines 1 and/or 1′ is now heated in a heat exchanger E1′ that is placed upstream from the compressor or compression unit V′, and preferably designed as an air heat exchanger and/or electric heater. While the outlet temperature of the hydrogen in the line 1 or 1′ corresponds to the boiling point of the supply tank S, and hence lies between approx. 21 and 50 K, the temperature at the inlet to the compressor V′ measures approx. −20 to −30° C. The compression work done by the compressor V′ heats up the compressed medium, so that its compressor outlet temperature measures approx. 10 to 150° C.

The compressed medium is cooled in a heat exchanger E1″ that is placed downstream from the compressor V′, and preferably coupled thermally with the heat exchanger E1′, preferably already to the desired storage temperature, e.g., of −20 or −40° C. If still required, approximation to the precise, desired storage temperature takes place in the heat exchanger E2. As an alternative to the approach shown on FIG. 2, the medium awaiting compression or already compressed can stream through the thermally coupled heat exchangers E1′ and E1″ in a parallel or counter flow.

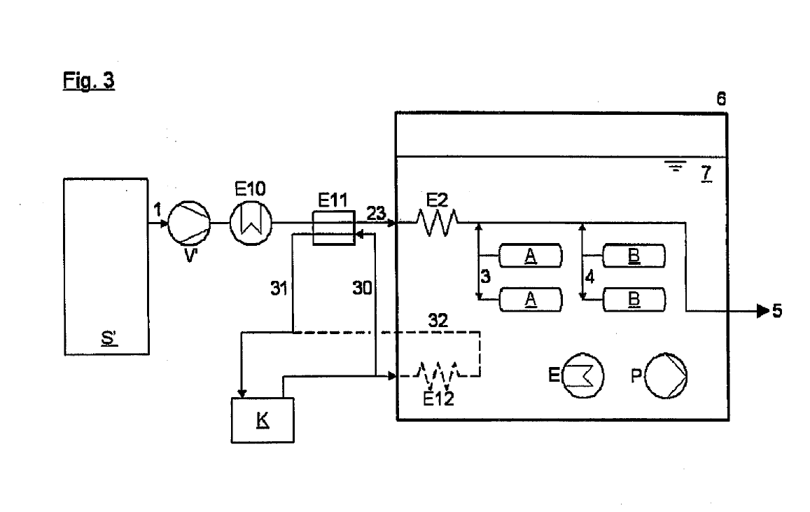

In the exemplary embodiment depicted on FIG. 3, the medium to be compressed is now stored in a supply tank S′, preferably in a compressed gas reservoir, which is suitable for storing media in a gaseous state. The hydrogen removed from the supply tank S′ by way of line 1 is now compressed to the desired pressure in a compressor or compression unit V′. The compression work of the compressor V′ heats up the compressed medium, so that its compressor outlet temperature measures approx. 10 to 150° C.

The compressed hydrogen is cooled to roughly ambient temperature or about 10 to 20° C. over the ambient temperature in the heat exchanger E10. The heat exchanger E10 is usually designed as an air-water heat exchanger. A cooling device X is used in the downstream heat exchanger E11 to cool the compressed hydrogen to the desired storage temperature. After it passes through the heat exchangers E10 and E11, the hydrogen cooled in this way is delivered to the high-pressure storage containers A/B by way of line 23.

The cooling device is connected with the heat exchanger E11 via coolant lines 30 and 31. As an option, the cooling device X can supply heat to the coolant 7 or remove heat from the coolant 7 via line 32 and heat exchanger E12.

The arrangement according to the invention and the method according to the invention for filling a storage container with a compressed medium now makes it possible to provide the medium to be delivered to a storage container to be filled at any time desired, without any pre-cooling or adjustment time at a desired or required temperature. By contrast, the desired low temperature is only available in the method encompassed by prior art with the pressure increasing means, e.g., the cryogenic pump, in operation. The required media mass flow was previously heated or cooled to the necessary temperature during each refueling process. However, this leads to the disadvantage of having to provide significant excess capacities to be able to respond to demand at short notice.

Let it be emphasized that both the arrangement according to the invention and the method according to the invention for filling a storage container with a compressed medium can be used in a plurality of applications, not just for refueling hydrogen vehicles. In particular, the invention always offers advantages when the object is to transfer a compressed medium into a storage container to be filled within a required temperature range and within a comparatively short filling period.

1. An arrangement for filling a storage container, with a compressed medium exhibiting
a) at least one supply tank, which is used to store the medium in a liquid or gaseous state,
b) at least one cryogenic pump and/or at least one compressor, which is used to compress the medium stored in the supply tank,
c) at least one high-pressure storage container, which is used to temporarily store the compressed medium, and
d) a system of lines through which the medium is delivered from the supply tank or high-pressure storage container to the storage container to be filled,
characterized in that cooling or heating means are allocated to the high-pressure storage container.

2. The arrangement according to claim 1, characterized in that the means for cooling or heating the high-pressure storage container(s) are designed as a container that envelops the high-pressure storage container, and accommodates a coolant.

3. The arrangement according to claim 2, characterized in that the container incorporates a recirculation pump, which is used to recirculate the coolant.

4. The arrangement according to claim 2, characterized in that the system of lines is cooled at least partially by means of a cooling medium, characterized in that the coolant is used as the cooling medium.

5. The arrangement according to claim 1, characterized in that the means for cooling or heating the high-pressure storage container are configured as a cooling or heating device allocated to the individual high-pressure storage container(s).

6. The arrangement according to claims 1, characterized in that the cryogenic pump or compressor have placed downstream from them at one heat exchanger, wherein the latter is preferably configured as an air heat exchanger or electric heater.

7. The arrangement according to claim 1, characterized in that the compressor has placed upstream from it at least one heat exchanger, wherein the latter is preferably configured as an air heat exchanger or electric heater.

8. The arrangement according to claim 1, characterized in that at least a partial area of the system of lines arranged inside the coolant is configured as a heat exchanger.

9. A method for filling a storage container, in particular a storage tank of a vehicle, with a compressed medium, in particular with compressed hydrogen, wherein the medium is temporarily stored in at least one high-pressure storage container, and immediately before being delivered to the storage container to be filled exhibits a temperature lying within a prescribed temperature interval, characterized in that the high-pressure storage container(s) used to temporarily store the medium are cooled or heated.

10. The method according to claim 9, characterized in that the medium temporarily stored in the high-pressure storage container(s) is now temporarily stored substantially at the temperature at which it is delivered to the storage container to be filled.

11. The arrangement according to claim 1 wherein said storage container is a storage tank of a vehicle.

12. The arrangement according to claim 1 wherein said compressed medium is compressed hydrogen.

13. The arrangement according to claim 2 wherein said coolant is selected from the group consisting of glycol-water mixture, cooling oil and a potassium formiate solution.

14. The arrangement according to claim 2 wherein an anti-corrosion additive is added to said coolant.
